(19) United States
(12) Patent Application Publication
(10) Pub. No.: US 2026/0108895 A1
(43) Pub. Date: Apr. 23, 2026

(54) WATER PAUSE STRUCTURE

(71) Applicants: Longyun SHI, Fujian (CN); Shifa HUANG, Fujian (CN); Guozhong WU, Fujian (CN)

(72) Inventors: Longyun SHI, Fujian (CN); Shifa HUANG, Fujian (CN); Guozhong WU, Fujian (CN)

(21) Appl. No.: 18/918,123

(22) Filed: Oct. 17, 2024

(51) Int. Cl. B05B 1/30; E03C 1/02; E03C 1/04

(52) U.S. Cl. CPC B05B 1/3013; E03C 1/0409; E03C 2001/026

(57) ABSTRACT

A water pause structure enabling convenient and effort saving operation, including a water flow-through piece, a water inlet piece, a driving assembly, a button, and a swinging block; the water flow-through piece has a water flow-through cavity; the water inlet piece has a water inlet and a water outlet that connects at a water inlet end of the water flow-through cavity; the driving assembly is movably fitted within the water flow-through cavity; a first end of the driving assembly penetrates through the water flow-through piece and always maintain sealed with the water flow-through piece, and a second end of the driving assembly is capable of opening or closing the water outlet; the button is located at one side of the driving assembly facing to the first end of the driving assembly; two ends of the swinging block abut against the button and the first end of the driving assembly respectively.

### BACKGROUND OF THE INVENTION

The present invention relates to the field of shower head technology, and in particular relates to a water pause structure.

Shower head is widely used, and can bring diversified and comfortable experiences for users during shower.

Water pause function of the shower head is different from the conventional on-off switch usually configured on a wall surface to allow or disallow outlet of water from the shower head in that it actually relates to a structure usually configured on the shower head itself for temporary stoppage of water outlet from the shower head.

In the prior art, the water pause function of a shower head is usually integrated with the water outlet modes switching structure of the shower head. Specifically, to switch different functions/modes, a button can be pressed to actuate a ratchet mounted on a back of a water discharge panel of the shower head to rotate the water discharge panel, and by successively pressing the button and thus rotating the water discharge panel successively, a water inlet end of the shower head will successively communicate with different water paths of the water discharge panel to achieve switching of different water outlet modes, and eventually, the water discharge panel can be rotated to a position that does not communicate with the water inlet end at all and thereby achieving the water pause function. However, it is obviously disadvantageous in that due to the need to rotate the water discharge panel successively, the water discharge panel has to be rotated to correspond to different water outlet modes first before it can be rotated to the position that corresponds to the water pause function. Such kind of operation is troublesome and inconvenient. An improved structure in the prior art in view of solving this problem configures a structure for the water pause function independently on a handle of the shower head, and the water pause function can therefore be achieved by pressing an independent button designated for this function.

Yet, the aforementioned improved structure in the prior still have the following problems: the structure for the water pause function currently mounted on the handle of the shower head is usually operated through a button that drive a piston to move in and out of the handle of the shower head along a radial direction of the handle of the shower head so as to allow and disallow water communicating between the water inlet end of the shower head and the water discharge panel. As such, a certain amount of space is required along the radial direction of the handle of the shower head for the button and piston to operate, and so the handle of the shower head cannot be made with a small diameter, and this cannot meet the current market demands for product portability and minimization.

### BRIEF SUMMARY OF THE INVENTION

It is an object of the present invention to provide a water pause structure to solve the problems in the prior art. According to the present invention, it is faster, easier, and more effort-saving to achieve a water pause function, and a diameter of the shower head handle can be made even smaller.

To attain the above object, the present invention provides the following technical solutions:

A water pause structure, comprising a water flow-through piece arranged in a shower head handle, a water inlet piece, a driving assembly, a button, and a swinging block; the water flow-through piece is provided with a water flow-through cavity; the water inlet piece connects and achieves a sealed effect with respect to a water inlet end of the water flow-through cavity, and is provided with a water inlet and a water outlet which is always biased to a closed state but being capable of communicating with the water flow-through cavity when opened; the driving assembly is movably fitted within the water flow-through cavity and is movable axially within the water flow-through cavity; a first end of the driving assembly penetrates through the water flow-through piece and yet always maintain sealed with the water flow-through piece, and a second end of the driving assembly is capable of opening or closing the water outlet as the driving assembly moves axially within the water flow-through cavity; the button is fitted in the shower head handle and is radially movable in the shower head handle, and is located at one side of the driving assembly facing to the first end of the driving assembly; the swinging block is rotatably fitted in the shower head handle, and two ends of the swinging block abut against the button and the first end of the driving assembly respectively; when the button is pressed, the swinging block is driven to swing and therefore push the driving assembly so as to open the water outlet.

The water flow-through piece is provided with an accommodation cavity in which the swinging block is movable therein.

Preferably, the button is movably fitted against an inner side wall of the accommodation cavity through a buckle; the shower head handle is provided with a through hole which the button passes through.

The driving assembly comprises a movable rod axially fitted within the water flow-through cavity and being movable axially within the water flow-through cavity; a first end of the movable rod penetrates through the water flow-through piece to be driven by the swinging block, and a second end of the movable rod achieves opening and closing of the water outlet when the movable rod moves axially in the water flow-through cavity.

Preferably, the driving assembly further comprises a movable sleeve fixed at the second end of the movable rod; a plurality of water flow-through holes are formed on a circumferential surface of the movable sleeve; the water outlet is formed on a circumferential surface of the water inlet piece, and the movable sleeve sleeves an outer side of the circumferential surface of the water inlet piece; when the movable sleeve and the movable rod synchronously move axially, the water flow-through holes are capable to be aligned with or misaligned with the water outlet.

Preferably, sealing rings are fixedly sleeved at the outer side of the circumferential surface of the water inlet piece at positions on two sides of the water outlet respectively, and the sealing rings always abut against an inner wall of the movable sleeve while the movable sleeve moves axially.

Preferably, the movable sleeve is fixed to the movable rod through threaded connection.

The driving assembly further comprises a piston rod movably fitted within the water inlet piece; the water outlet is formed on an end surface of the water inlet piece; the piston rod blocks the water outlet by action force of water pressure within the water inlet piece; the second end of the movable rod abuts against an end of the piston rod.

Preferably, the water inlet piece comprises a body and an end cover separately constructed but assembled together through buckling connection; the water inlet is formed on an end surface of the body, and the water outlet is formed on an end surface of the end cover.

Preferably, an annular portion is formed protruding out radially from a circumferential surface of the piston rod.

Preferably, the driving assembly further comprises a press mechanism; a fixing seat rests on outer surfaces of the water flow-through piece to axially limit the press mechanism; the press mechanism comprises a driver part and a driven part coaxially arranged and abuttable with each other through corresponding end surfaces; the driven part is rotatable with respect to the driver part; an end of the driver part facing away from the driven part penetrates through the fixing seat and abuts against the swinging block; an end of the driven part facing away from the driver part abuts against the first end of the movable rod; said corresponding end surfaces of the driver part and the driven part are provided with a plurality of driver blocks and a plurality of grooves respectively; each of the driver blocks has a driving inclined surface; each of the grooves has a driven inclined surface; depths of two adjacent grooves are different.

Preferably, the driver part is provided with a rod sleeve; the driven part is provided with a guiding rod; the guiding rod is movably inserted into the rod sleeve.

The button and the buckle are separate components assembled together through buckling connection.

According to the above technical solutions, the present invention has the following beneficial effects:
(1) The water pause structure of the present invention is mounted on the shower head handle. When holding the shower head handle, user can press the button using a finger, and then the button will drive the swinging block to move the driving assembly to open or close the water outlet. When the water outlet is closed, the water pause function is achieved. Accordingly, the water pause structure of the present invention enables single hand operation. It is therefore not necessary to switch different functions/modes successively before achieving the water pause function as required in the prior art, and so the operation according to the present invention is faster and more convenient.
(2) The driving assembly moves in the shower head handle along an axial direction of the shower head handle which is a direction consistent with a direction of water flow in the shower head handle. Therefore, the driving assembly does not require extra space to move along a radial direction of the shower head handle, and so a diameter of the shower head handle can be made even smaller.
(3) A counter force of water pressure experienced when pressing the button only comes from the water outlet of the water inlet piece, the resistance created by the counter force of the water pressure is small, and so operation is easier and more effort-saving.

### BRIEF DESCRIPTION OF THE DRAWINGS

FIG. 1 is a schematic view of a first embodiment of the present invention in a water pause state;

FIG. 2 is a schematic view of the first embodiment of the present invention in a water discharge state;

FIG. 3 is a perspective view of some components of the first embodiment of the present invention;

FIG. 4 is an exploded view of a press mechanism of the first embodiment of the present invention;

FIG. 5 is a schematic view of a second embodiment of the present invention in a water pause state;

FIG. 6 is a schematic view of the second embodiment of the present invention in a water discharge state; and

FIG. 7 is a perspective view of some components of the second embodiment of the present invention.

### DETAILED DESCRIPTION OF THE INVENTION

To further explain the technical solutions of the present invention, a detailed description of the present invention is provided below through specific embodiments.

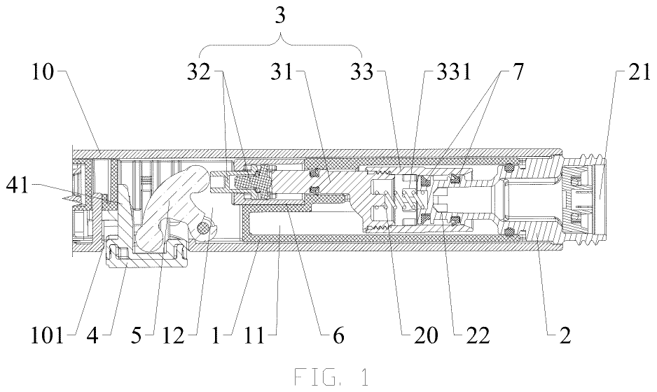

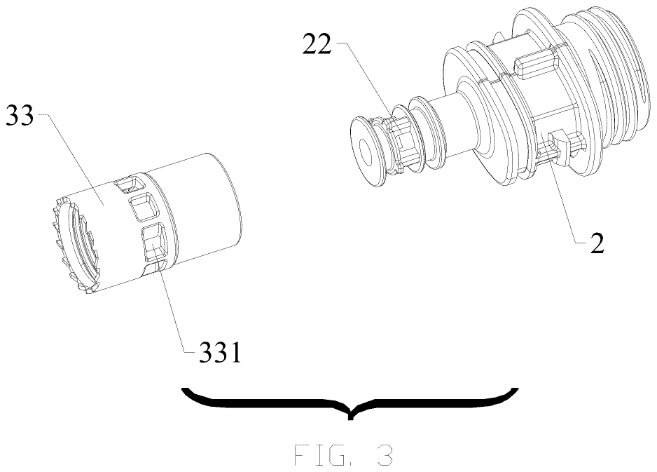

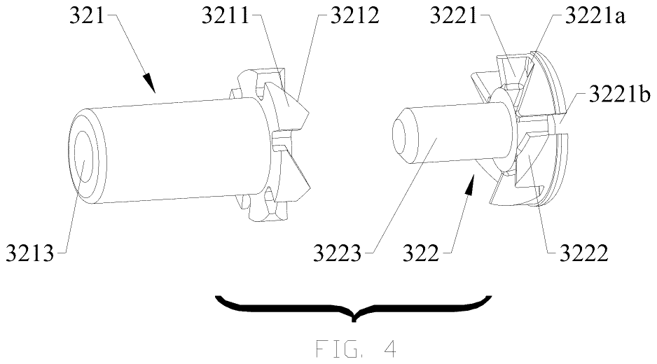

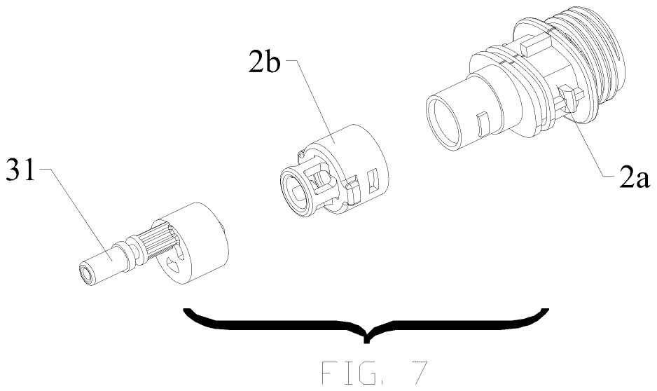

With reference to FIGS. 1 to 7, a water pause structure is disclosed, comprising a water flow-through piece 1 arranged in a shower head handle 10, a water inlet piece 2, a driving assembly 3, a button 4, and a swinging block 5.

The water flow-through piece 1 is provided with a water flow-through cavity 11, and a water outlet end of the water flow-through cavity 11 is configured to communicate with a water discharge panel of the shower head or other water discharge devices of the shower head.

The water inlet piece 2 connects and achieves a sealed effect with respect to a water inlet end of the water flow-through cavity 11, and is provided with a water inlet 21 configured to communicate with a water source and a water outlet 22 which is always biased to a closed state but being capable of communicating with the water flow-through cavity 11 when opened.

The driving assembly 3 is movably fitted within the water flow-through cavity 11 and is movable axially within the water flow-through cavity 11; a first end of the driving assembly 3 penetrates through the water flow-through piece 1 and yet always maintain sealed with the water flow-through piece 1, and a second end of the driving assembly 3 is capable of opening or closing the water outlet 22 as the driving assembly 3 moves axially within the water flow-through cavity 11.

The button 4 is fitted in the shower head handle 10 and is radially movable in the shower head handle 10, and is located at one side of the driving assembly facing to the first end of the driving assembly 3.

The swinging block 5 is rotatably fitted in the shower head handle 10, and two ends of the swinging block 5 abut against the button 4 and the first end of the driving assembly 3 respectively.

When the button 4 is pressed, the swinging block 5 will be driven to swing and therefore push the driving assembly 3 so as to open the water outlet 22, such that water fed from the water inlet piece 2 can flow to the water flow-through cavity 11, thereby achieving water discharge of the shower head.

The directions “axially” and “radially” described above are defined according to an extension direction of the shower head handle 10.

According to the above technical solutions, the water pause structure of the present invention is mounted on the shower head handle 10. When holding the shower head handle 10, user can press the button 4 using a finger, and then the button 4 will drive the swinging block 5 to move the driving assembly 3 to open or close the water outlet 22. When the water outlet 22 is closed, the water pause function is achieved. Accordingly, the water pause structure of the present invention enables single hand operation. It is therefore not necessary to switch different functions/modes successively before achieving the water pause function as required in the prior art, and so the operation according to the present invention is faster and more convenient. Also, the driving assembly 3 moves in the shower head handle 10 along an axial direction of the shower head handle 10 which is a direction consistent with a direction of water flow in the shower head handle 10, the driving assembly 3 does not require extra space to move along a radial direction of the shower head handle 10, and so a diameter of the shower head handle 10 can be made even smaller. Further, a counter force of water pressure experienced when pressing the button 4 only comes from the water outlet 22 of the water inlet piece 2, the resistance created by the counter force of the water pressure is small, and so operation is easier and more effort-saving.

In some embodiments of the present invention, the water flow-through piece 1 is provided with an accommodation cavity 12 in which the swinging block 5 is movable therein; a water path inside the water flow-through piece 1 is routed to two peripheral sides of the accommodation cavity 12 and then communicates with the water discharge panel or other water discharge devices of the shower head.

Furthermore, the button 4 is movably fitted against an inner side wall of the accommodation cavity 12 through a buckle 41, such that the button 4 is prevented from falling out of the shower head handle 10; the shower head handle 10 is provided with a through hole 101 which the button 4 passes through.

In some embodiments of the present invention, a spring 20 is arranged between the driving assembly 3 and the water inlet piece 2 to reset the driving assembly 3 and maintain the water outlet 22 to be always biased to the closed state; alternatively, the driving assembly 3 may be reset by directly using water pressure.

In some embodiments of the present invention, the driving assembly 3 comprises a movable rod 31 axially fitted within the water flow-through cavity 11 and being movable within the water flow-through cavity 11; a first end of the movable rod 31 penetrates through the water flow-through piece 1 to be driven by the swinging block 5, and a second end of the movable rod 31 achieves opening and closing of the water outlet 22 when the movable rod 31 moves axially in the water flow-through cavity 11.

Furthermore, the driving assembly 3 further comprises a press mechanism 32 operating according to the principle similar to a conventional click pen mechanism found in a conventional click pen. A fixing seat 6 rests on outer surfaces of the water flow-through piece 1 to axially limit the press mechanism 32. Specifically, the press mechanism 32 comprises a driver part 321 and a driven part 322 coaxially arranged and abuttable with each other through corresponding end surfaces; the driven part 322 is rotatable with respect to the driver part 321; an end of the driver part 321 facing away from the driven part 322 penetrates through the fixing seat 6 and abuts against the swinging block 5; an end of the driven part 322 facing away from the driver part 321 abuts against the first end of the movable rod 31; said corresponding end surfaces of the driver part 321 and the driven part 322 are provided with a plurality of driver blocks 3211 (on the driver part 321) and a plurality of grooves 3221 (on the driven part 322) respectively; each of the driver blocks 3211 has a driving inclined surface 3212; each of the grooves 3221 has a driven inclined surface 3222; depths (a distance between a top and a bottom of each groove 3221) of two adjacent grooves 3221 are different. For example, bottoms of the grooves 3221 are formed as closed bottoms 3221 and opened bottoms 3221b arranged alternately around the driven part 322, so that when the driver part 321 is pressed, the driving inclined surface 3212 of each of the driver blocks 3211 leaves a corresponding groove 3221 in which it is initially positioned and then engages with the driven inclined surface 3222 of an adjacent groove 3221 and therefore rotate the driven part 322 by allowing the driven inclined surface 3222 of the adjacent groove 3221 to slide along the driving inclined surface 3212, as a result, each driver part 321 will then be located to the corresponding adjacent groove 3221. Since as mentioned before, the depths of adjacent grooves 3221 are different, each press of the driver part 321 will cause each driver block 3211 to engage with a respective adjacent groove 3221 which has a different depth than a previous groove 3221 in which the driver block 3211 is positioned, therefore, a relative axial distance of the driven part 322 with respect to the driver part 321 changes every time when the driver part 321 is pressed, depending on which groove 3221 each driver block 3211 is positioned into. Accordingly, depending on different relative distances between the driven part 322 with respect to the driver part 321, the movable rod 31 is driven by the driven part 322 to move by different distances. Further, the movable rod 31 is always biased to abut against the driven part 322 due to the elastic force of the spring 20. In case of the example given above where the bottoms of the grooves 3221 are formed as the closed bottoms 3221 and the opened bottoms 3221b arranged alternately around the driven part 322, successive presses of the button 4 can alternate two different axial positions of the movable rod 31 in the water flow-through cavity 11 corresponding to a water outlet 22 opened position and a water outlet 22 closed position. Further, after each press of the button 4, user can release and not pressing the button 4, and the axial position of the movable rod 31 caused by each press can still be maintained such that the movable rod 31 can be maintained at the water outlet 22 opened position or the water outlet 22 closed position. Compared with the prior art, this way of operating the shower head is improved in that after the button 4 is pressed to activate or inactivate the water pause function, it is not required to press and hold the button 4 to achieve the intended effect, thereby facilitating the operation.

Moreover, the driver part 321 is provided with a rod sleeve 3213; the driven part 322 is provided with a guiding rod 3223; the guiding rod 3223 is movably inserted into the rod sleeve 3213, so that axial movement of the driven part 322 relative to the driver part 321 can be guided. Also, the guiding rod 3223 also serves as a rotational axis of rotational movement of the driven part 322 relative to the driver part 321. The driver blocks 3211 are arranged evenly on a periphery of the rod sleeve 3213; the grooves 3221 are arranged evenly on a periphery of the guiding rod 3223.

Referring to FIGS. 1 to 4, a first embodiment of the present invention is shown.

In the first embodiment, the driving assembly 3 further comprises a movable sleeve 33 fixed at the second end of the movable rod 31; a plurality of water flow-through holes 331 are formed on a circumferential surface of the movable sleeve 33; the water outlet 22 is formed on a circumferential surface of the water inlet piece 2, and the movable sleeve 33 sleeves an outer side of the circumferential surface of the water inlet piece 2; when the movable sleeve 33 and the movable rod 31 synchronously move axially, the water flow-through holes 331 are capable to be aligned with or misaligned with the water outlet 22, such that the water outlet 22 is opened or closed respectively.

Furthermore, sealing rings 7 are fixedly sleeved at the outer side of the circumferential surface of the water inlet piece 2 at positions on two sides of the water outlet 22 respectively, and the sealing rings 7 always abut against an inner wall of the movable sleeve 33 while the movable sleeve 33 moves axially so as to always achieve a sealing effect. By arranging the sealing rings 7 on two sides of the water outlet 22 respectively, water leakage will not occur when the water flow-through holes 331 of the movable sleeve 33 are misaligned with the water outlet 22 of the water inlet piece 2, and when the water flow-through holes 331 are misaligned with the water outlet 22, the water flowing out from the water outlet 22 will flow towards opposite directions to act on the sealing rings 7 on the two sides, thereby offsetting the water pressure which is initially directed only to a single direction against the movable rod 31. Accordingly, counter force due to the water pressure will barely be experienced when the button 4 is pressed, thereby facilitating easier and effort-saving push of the driving assembly 3.

Further, the movable sleeve 33 is fixed to the movable rod 31 through threaded connection, thus making assembly and disassembly more convenient.

In addition, in the first embodiment, the button 4 and the buckle 41 are separate components assembled together through, for example, screw connection, interference fit, or buckling connection; the button 4 and the buckle 41 may be made of materials of different textures/colors, thereby facilitating differentiation of their appearance, so that when the buckle 41 is exposed from an outer surface of the shower head handle 10, it can be observed more easily to facilitate indication that the shower head is in a water pause state. When color spraying method is adopted, only the buckle 41 needs to be sprayed with color, and the button 4 is not required to be sprayed with color, thus saving the cost.

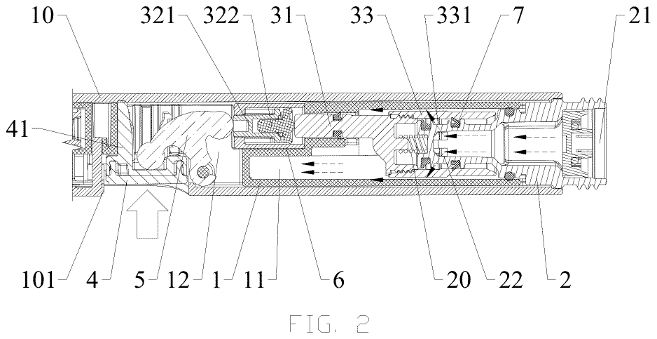

Referring to FIG. 2, when the user presses the button 4, the button 4 drives the swinging block 5 which drives the press mechanism 32 which then drive the movable rod 31 to move the movable sleeve 33 axially, such that the water flow-through holes 331 of the movable sleeve 33 are aligned with the water outlet 22 of the water inlet piece 2, and so water entering the water inlet piece 2 will flow into the water flow-through cavity 11 through the water outlet 22 and the water flow-through holes 331.

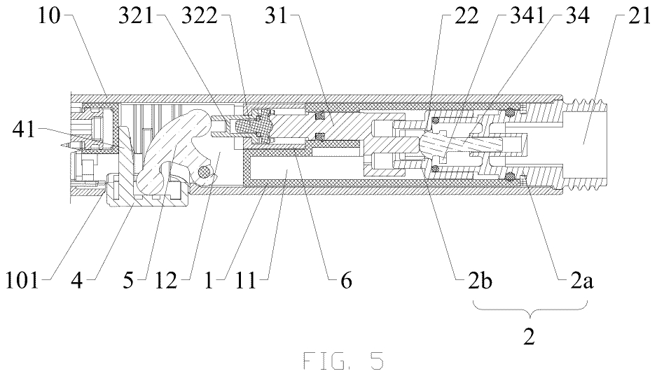

Referring to FIGS. 5 to 7, a second embodiment of the present invention is shown.

In the second embodiment, the driving assembly 3 further comprises a piston rod 34 movably fitted within the water inlet piece 2; the water outlet 22 is formed on an end surface of the water inlet piece 2; the piston rod 34 blocks the water outlet 22 by action force of water pressure within the water inlet piece 2; the second end of the movable rod 31 abuts against an end of the piston rod 34, such that the piston rod 34 is capable to be pushed away from the water outlet 22 when the movable rod 31 moves axially to push the piston rod 34.

Furthermore, the water inlet piece 2 comprises a body 2a and an end cover 2b separately constructed but assembled together through buckling connection, thereby facilitating installation of the piston rod 34 within the water inlet piece 2; also, the piston rod 34 is prevented from falling out of the body 2a due to the end cover 2b; the water inlet 21 is formed on an end surface of the body 2a, and the water outlet 22 is formed on an end surface of the end cover 2b.

Also, an annular portion 341 is formed protruding out radially from a circumferential surface of the piston rod 34; the annular portion 341 serves to increase a sectional area of the piston rod 34, thereby facilitating pushing the piston rod 34 to move by the water entering into the water inlet piece 2, so that the piston rod 34 can be reset by using the water pressure to close the water outlet 22.

In addition, the second embodiment is different from the first embodiment in that, the button 4 and the buckle 41 are formed integrally as one piece, and in this case, the button 4 may made by overmolding materials of two different colors, or may be sprayed with different colors etc such that an end surface and side surfaces of the button 4 present different colors, thereby facilitating differentiation in appearance; when the button 4 is exposed out from the outer surface of the shower head handle 10, the side surfaces (typically designed to have a more prominent color) of the button can be observed by the user to remind the user that the shower head is currently in a water pause state.

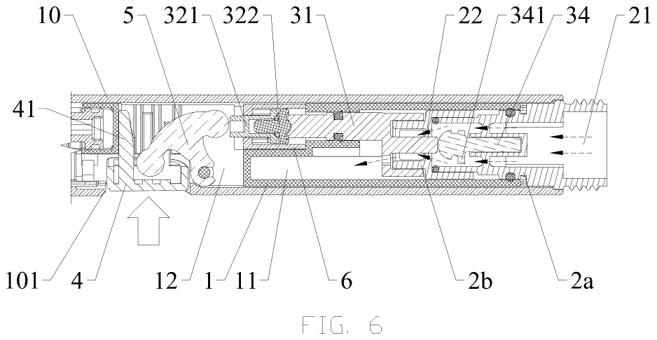

Referring to FIG. 6, when the user presses the button 4, the button 4 drives the swinging block 5 which drives the press mechanism 32 which then drives the movable rod 31 to move the piston rod 34 such that the piston rod 34 moves away from the water outlet 22 along an axial direction, and water entering the water inlet piece 2 can flow into the water flow-through cavity 11 through the water outlet 22.

The above embodiments and illustrations are not intended to limit the form and type of the product of the present invention. Any appropriate variations or modifications made by those of ordinary skills in the art within the scope of the present invention shall be considered as falling within the scope of the invention.

What is claimed is:

1. A water pause structure, comprising:
a water flow-through piece arranged in a shower head handle, a water inlet piece, a driving assembly, a button, and a swinging block;
the water flow-through piece is provided with a water flow-through cavity;
the water inlet piece connects and achieves a sealed effect with respect to a water inlet end of the water flow-through cavity, and is provided with a water inlet and a water outlet which is always biased to a closed state but capable of being in communication with the water flow-through cavity when opened;
the driving assembly is movably fitted within the water flow-through cavity and is movable axially within the water flow-through cavity; a first end of the driving assembly penetrates through the water flow-through piece and yet always maintain sealed with the water flow-through piece, and a second end of the driving assembly is capable of opening or closing the water outlet as the driving assembly moves axially within the water flow-through cavity;
the button is fitted in the shower head handle and is radially movable in the shower head handle, and is located at one side of the driving assembly facing to the first end of the driving assembly;
the swinging block is rotatably fitted in the shower head handle, and two ends of the swinging block abut against the button and the first end of the driving assembly respectively;
when the button is pressed, the swinging block is driven to swing and therefore push the driving assembly so as to open the water outlet.

2. The water pause structure of claim 1, wherein the water flow-through piece is provided with an accommodation cavity in which the swinging block is movable therein.

3. The water pause structure of claim 2, wherein the button is movably fitted against an inner side wall of the accommodation cavity through a buckle; the shower head handle is provided with a through hole which the button passes through.

4. The water pause structure of claim 1, wherein the driving assembly comprises a movable rod axially fitted within the water flow-through cavity and being movable axially within the water flow-through cavity; a first end of the movable rod penetrates through the water flow-through piece to be driven by the swinging block, and a second end of the movable rod achieves opening and closing of the water outlet when the movable rod moves axially in the water flow-through cavity.

5. The water pause structure of claim 4, wherein the driving assembly further comprises a movable sleeve fixed at the second end of the movable rod; a plurality of water flow-through holes are formed on a circumferential surface of the movable sleeve; the water outlet is formed on a circumferential surface of the water inlet piece, and the movable sleeve sleeves an outer side of the circumferential surface of the water inlet piece; when the movable sleeve and the movable rod synchronously move axially, the water flow-through holes are capable to be aligned with or misaligned with the water outlet.

6. The water pause structure of claim 5, wherein sealing rings are fixedly sleeved at the outer side of the circumferential surface of the water inlet piece at positions on two sides of the water outlet respectively, and the sealing rings always abut against an inner wall of the movable sleeve while the movable sleeve moves axially.

7. The water pause structure of claim 4, wherein the driving assembly further comprises a piston rod movably fitted within the water inlet piece; the water outlet is formed on an end surface of the water inlet piece; the piston rod blocks the water outlet by action force of water pressure within the water inlet piece; the second end of the movable rod abuts against an end of the piston rod.

8. The water pause structure of claim 7, wherein the water inlet piece comprises a body and an end cover separately constructed but assembled together through buckling connection; the water inlet is formed on an end surface of the body, and the water outlet is formed on an end surface of the end cover.

9. The water pause structure of claim 7, wherein an annular portion is formed protruding out radially from a circumferential surface of the piston rod.

10. The water pause structure of claim 4, wherein the driving assembly further comprises a press mechanism; a fixing seat rests on outer surfaces of the water flow-through piece to axially limit the press mechanism; the press mechanism comprises a driver part and a driven part coaxially arranged and abuttable with each other through corresponding end surfaces; the driven part is rotatable with respect to the driver part; an end of the driver part facing away from the driven part penetrates through the fixing seat and abuts against the swinging block; an end of the driven part facing away from the driver part abuts against the first end of the movable rod; said corresponding end surfaces of the driver part and the driven part are provided with a plurality of driver blocks and a plurality of grooves respectively; each of the driver blocks has a driving inclined surface; each of the grooves has a driven inclined surface; depths of two adjacent grooves are different.

11. The water pause structure of claim 10, wherein the driver part is provided with a rod sleeve; the driven part is provided with a guiding rod; the guiding rod is movably inserted into the rod sleeve.

12. The water pause structure of claim 1, wherein the button and the buckle are separate components assembled together through buckling connection.
